(19) United States
(12) Patent Application Publication
(10) Pub. No.: US 2006/0220363 A1
(43) Pub. Date: Oct. 5, 2006

(54) Gas generating system with autoignition device

(76) Inventor: Jeffery S. Blackburn, Lake Orion, MI (US)

Correspondence Address: L. C. Begin & Associates, PLLC, PMB 403, 510 Highland Avenue, Milford, MI, 48381, US

(21) Appl. No.: 11/395,478

(22) Filed: Mar. 30, 2006

Related U.S. Application Data
(60) Provisional application No. 60/666,958, filed on Mar. 31, 2005.

(51) Int. Cl. B60R 21/26; C06D 5/00

(52) U.S. Cl. 280/736; 222/5; 60/254; 102/531

(57) ABSTRACT

A gas generating system (10) includes an autoignition device (300) for initiating combustion of a combustible material (14, 38). The device comprises a cartridge including a container (302), a first material (314) stored in the container (302), and a second material (316) stored in the container (302). The second material (316) is separated from the first material (314). The first material (314) and the second material (316) combine to form a hypergolic mixture upon contact with each other. Upon exposure of the gas generating system (10) to an elevated temperature, a portion of the container (302) separating the first and second materials (314, 316) is breached, enabling the materials to combine to form the hypergolic mixture. The resulting hypergolic ignition ignites one or more combustible materials (14, 38) positioned within the gas generating system housing (11). Also provided is a structure for the autoignition device, and methods for activating the device.

### CROSS REFERENCE TO RELATED APPLICATIONS

This application claims the benefit of provisional application Ser. No. 60/666,958 filed Mar. 31, 2005.

### TECHNICAL FIELD

The present invention relates generally to gas generating systems and, more particularly, to pyrotechnic gas generating systems having an autoignition device for igniting a gas generant when the gas generating system is exposed to elevated temperatures.

### BACKGROUND OF THE INVENTION

Inflatable restraint systems or “airbag” systems have become a standard feature in many new vehicles. These systems have made significant contributions to automobile safety. However, as with the addition of any standard feature, they increase the cost, manufacturing complexity and weight of most vehicles. Technological advances addressing these concerns are therefore welcomed by the industry. In particular, the gas generating system or inflator used in many occupant restraint systems tends to be the heaviest, most complex component of the restraint system. Thus, simplifying the design and manufacturing of airbag inflators, while retaining optimal function, has long been a goal of automotive engineers.

In addition, the housings of gas generating systems may be formed from lightweight materials, such as aluminum. These lightweight materials can lose strength at abnormally high temperatures, such as those experienced in a vehicle fire. At temperatures experienced in a vehicle fire, a gas generant material contained in the housing may ignite and produce an inflation gas. The pressure of the inflation gas can cause the housing to lose its structural integrity due to the reduced strength of the housing material. To prevent such loss of structural integrity, gas generating systems typically include an autoignition material that will autoignite and initiate combustion of the gas generant when exposed to a temperature below that at which the housing material begins to lose a significant percentage of its strength. Autoignition insures that the gas generating system functions in a safe manner and minimizes risk from system deployment at temperatures outside the design limits.

### SUMMARY OF THE INVENTION

In accordance with the present invention, a gas generating system is provided which includes an autoignition device for initiating combustion of a combustible material. The device comprises a cartridge formed from a container, a first material stored in the container, and a second material stored in the container. The second material is separated from the first material. The first material and the second material combine to form a hypergolic mixture upon contact with each other. Upon exposure of the gas generating system to an elevated temperature (or upon the occurrence of some other predefined triggering event), a portion of the container separating the first and second materials is breached, enabling the materials to combine to form the hypergolic mixture. The resulting hypergolic ignition ignites one or more combustible materials positioned within the gas generating system housing.

In another aspect of the invention, a method of forming a hypergolic mixture is provided. The method includes the steps of positioning a first component of the hypergolic mixture in a container; positioning a second component of the hypergolic mixture in the container separated from the first component; and breaching at least a portion of the container so as to provide contact between the first component and the second component, thereby forming the hypergolic mixture.

In yet another aspect of the invention, a method of igniting a combustible material is provided. The method includes the steps of positioning a first component of a hypergolic mixture in a container; positioning a second component of the hypergolic mixture in the container separated from the first component; and breaching at least a portion of the container so as to provide contact between the first component and the second component proximate the combustible material, thereby forming a hypergolic mixture proximate the combustible material to ignite the combustible material.

In yet another aspect of the invention, a gas generating system is provided including a housing, a gas generant positioned in the housing, and an ignition device for igniting the gas generant. The ignition device includes a container, a first material stored in the container, and a second material stored in the container. The second material is separated from the first material such that a breach in the separation enables the first material to contact the second material, wherein the first material and the second material form a hypergolic mixture upon contact with each other to ignite the gas generant.

### BRIEF DESCRIPTION OF THE DRAWINGS

FIG. 1 is a cross-sectional side view of a gas generating system in accordance with one embodiment of the present invention;

FIG. 2 is an autoignition device in accordance with one embodiment of the present invention, for incorporation into the gas generating system of FIG. 1; and

FIG. 3 is a schematic view of an exemplary gas generating system as employed in a vehicle occupant protection system, in accordance with the present invention.

### DETAILED DESCRIPTION

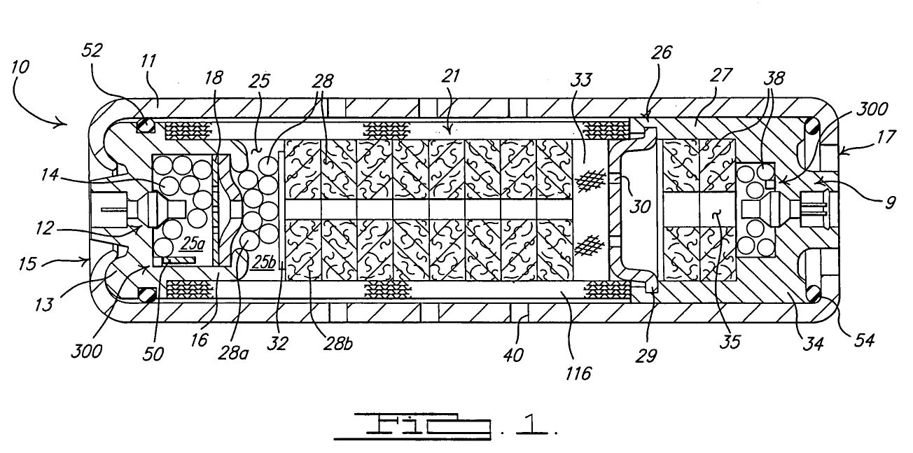

Referring to FIG. 1, there is shown an exemplary gas generating system 10 according to a first embodiment of the present invention. In this embodiment, gas generating system 10 is designed for use with an inflatable restraint system in an automobile, supplying inflation gas for inflation of a conventional airbag cushion or other inflatable passenger restraint device, a function well known in the art. Gas generating system 10 utilizes two gas generant or propellant charges, described herein, wherein the propellant charges are ignited in separate combustion chambers, and discharge inflation gas via a common plenum 21. Gas generating system 10 further provides independently operable initiators for igniting the respective propellant charges, thus imparting significant flexibility to the available operating schemes for the gas generating system. For instance, both sequential and serial firing of the two charges is possible, depending on the optimal deployment of the associated airbag. It is contemplated that gas generating system 10 will find greatest utility in passenger-side airbag systems; however, other applications are possible without departing from the scope of the present invention. All the components of the present invention are formed from known materials that are readily available commercially, and are made by known processes.

Gas generating system 10 includes an elongate pressure vessel or housing 11, preferably a hollow steel cylinder. Housing 11 is characterized by a first end 15 and a second end 17, and includes a plurality of inflation apertures 40 that allow fluid communication between the exterior of the gas generating system housing and plenum 21. A first end closure 13 is positioned at first end 15 of housing 11, preferably creating a fluid seal therewith. A second end closure 34 is preferably positioned at second end 17, also preferably creating a fluid seal with housing 11. Closures 13 and 34 are preferably formed from a thermally-conductive material, such as a metal or metal alloy. First end 15 and second end 17 are preferably crimped inwardly to hold first and second closures 13 and 34 in place, however, some other suitable method such as welding or mating threads on housing 11 and the respective closures might be used. In addition, rubber O-rings 52, 54 may be positioned around closures 13 and 34, respectively, creating or enhancing seals with housing 11.

Gas generating system 10 includes a first combustion chamber 25, within which a quantity of gas generant material or first propellant charge 28 is placed. In the embodiment shown in FIG. 1, chamber 25 comprises a significant proportion of the interior of gas generating system housing 11, defined in part by longitudinal walls of housing 11, and in part by first end closure 13. Plenum 21 occupies a region of chamber 25 adjacent the walls of housing 11, where inflation gas is passed to apertures 40. Thus, chamber 25 and plenum 21 are at least partially coextensive. The phrase “at least partially coextensive” should be understood to include gas generating system designs wherein chamber 25 is subdivided by foils, burst shims, etc., as described herein, as well as designs wherein chamber 25 is uninterrupted by such features. First end closure 13 preferably includes a cylindrical extension 16 wherein a perforated disk 18 is positioned, separating chamber 25 into two sub-chambers 25a and 25b. An initiator assembly 12, preferably including a conventional igniter or squib, is positioned at first end 15, and preferably mounted in first end closure 13 such that it can ignite compositions in chamber 25. A second initiator assembly 9, also preferably including a conventional igniter or squib, is positioned at second end 17.

Propellant charge 28 may be any suitable gas generant composition known in the art, preferably a non-azide composition such as ammonium nitrate. Exemplary, but not limiting formulations are described in U.S. Pat. Nos. 5,872,329, 5,756,929, and 5,386,775. In a particular embodiment, propellant charge 28 is provided in both tablet 28a and wafer 28b forms, both of which are illustrated in FIG. 1. The tablets 28a and wafers 28b may be different compositions, but are preferably the same material in different, commercially available forms. In the embodiment shown in FIG. 1, a retainer disk 32 separates tablets 28a from wafers 28b. Disk 32 may be made from a relatively porous material such that a flame front or heat from ignition of tablets 28a can ignite wafers 28b, or it may be made from a known material that allows ignition of wafers 28b by heat convection from the burning of tablets 28a. A quantity of booster propellant 14 is preferably placed in sub-chamber 25a, and is ignitable via initiator 12 in a conventional manner to ignite and enhance the burn characteristics of the first propellant charge 28a and 28b.

In accordance with the present invention, a cushion 33 is positioned between propellant tablets 28b and a cap 29, thereby inhibiting fracture of the tablets 28b. In further accordance with the present invention, the cushion 33 is formed from a composition containing silicone and a desiccating material such as synthetic zeolites, calcium oxide, and/or calcium sulfate. The composition of cushion 33 preferably has a silicone to desiccating material ratio ranging from 20/80 to 50/50. It will be appreciated that cushion 33 may also be positioned anywhere within the gas generating system 10, and may provide a resilient support wherever required therein. Accordingly, the shape of the cushion 33 is not limited to the exemplary structure shown. In another aspect of the present invention, the cushion also absorbs other undesirable gases thereby improving the quality of the gaseous effluent upon gas generating system activation. In still a further advantage, the cushion is made from a lightweight material rather than a typical wire mesh material, thereby reducing the overall weight of the gas generating system 10 or gas generating system 10 associated therewith.

A partitioning assembly 26 is positioned proximate second end 17, and preferably comprises a substantially cylindrical base member 27 and a cap 29. Base member 27 and cap 29 define a second combustion chamber 35 that at least partially encases a second quantity of propellant 38, preferably in both tablet and wafer form. Base member 27 and second end closure 34 may be the same piece, as in one preferred embodiment, or a plurality of separate, attached pieces might be used. In a preferred embodiment, partitioning assembly 26 is formed structurally independent from housing 11. Partitioning assembly 26 is an independent piece having no physical attachment to the longitudinal sidewall of housing 11. During assembly of gas generating system 10, partitioning assembly 26 is slid into position in housing 11, and housing second end 17 is crimped inwardly to secure assembly 26 therein. Thus, other than securing second end closure 34, no modifications are made to housing 11 to accommodate or otherwise secure the components defining second combustion chamber 35.

Cap 29 preferably includes a plurality of apertures 30 that can connect second chamber 35 with plenum 21 (as well as with first chamber 25, since plenum 21 and chamber 25 are fluidly connected and partially coextensive). In a particular embodiment, a foil or burst shim (not shown) is placed across apertures 30 to block fluid communications between chambers 25 and 35. It should be appreciated, however, that the foil or burst shim is positioned and/or manufactured such that it will not burst inwardly, i.e. in the direction of housing second end 17 during combustion of propellant in chamber 25. Combustion of propellant in second chamber 35, on the other hand, is capable of bursting the foil or shim outwardly, allowing the combustion products in chamber 35 to escape to plenum 21/first chamber 25, and thereby discharge from gas generating system housing 11. The preferred foils and shims, and the described methods of mounting them are all known in the art. By fluidly isolating first and second chambers 25 and 35, sympathetic ignition of the propellant in chamber 35 during combustion of the propellant in chamber 25 can be avoided, as described herein. The outer diameter of base member 27 is preferably substantially equal to the inner diameter of housing 11, such that base member 27 is nested (i.e. fits relatively snugly) therein. Because both second end closure 34 and housing 11 are preferably substantially cylindrical, the two components are preferably axially aligned.

In a preferred embodiment, wafers 28b are positioned in a stack in plenum 21. A spring (not shown), for example, a conventional bell spring, is positioned adjacent the wafer stack, and biases the entire stack toward first end 15. Wafers 28b, in turn, preferably bias disk 32 against tablets 28a, preventing tablets 28a from being jostled while the gas generating system is idle long periods, helping avoid mechanical degradation of tablets 28a.

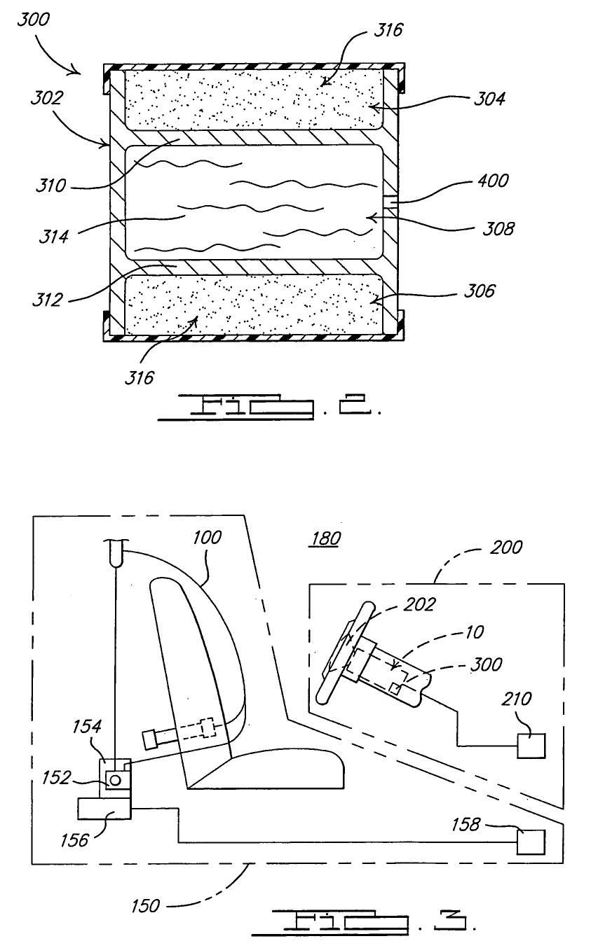

In yet another aspect of the invention and with reference to FIG. 2, an autoignition device 300 is provided. In one embodiment, autoignition device 300 comprises a cartridge including a container 302 having a first material 314 and a second material 316 stored in the container. Second material 316 is separated from first material 314, and the first and second materials are specified so as to form a hypergolic mixture upon contact with each other. Autoignition device 300 is designed to ignite or combust at a temperature lower than that which would lead to catastrophic failure (i.e. explosion, fragmentation, or rupture) of the gas generating system upon ignition. As used herein, the term “cartridge” is understood to mean “a modular unit designed to be inserted into a larger piece of equipment.” Also as used herein, the term “fusible” is understood to mean “capable of being fused or melted by heating.” Also as used herein, the term “breach” is understood to refer to an opening, tear, hole, rupture, gap or rift.

At least two chambers are formed within container 302, each chamber containing one of first material 314 and second material 316. In the embodiment shown in FIG. 3, three chambers 304, 306, and 308 are formed within the container 302. Chambers 304, 306, and 308 are effectively separated by walls 310 and 312 so as to enable first material 314 to contact second material 316 upon breaching of either of the walls.

Walls 310 and 312 or the entire container 302 may be formed from a fusible material. In one embodiment, walls 310 and 312 are formed from a metallic material having a melting point in the range 120° C.-150° C. Walls 310 and 312 or the entire container may be formed from a metal alloy that melts within the desired temperature range. Examples of suitable materials include alloys of two or more of the following metals: bismuth, lead, tin, cadmium, antimony, and indium. In a particular embodiment, the metallic material is an alloy comprising approximately 58% bismuth and approximately 42% tin by weight, with a melting point of about 138° C. The metallic material forming walls 310, 312 or the entire container 302 may also be formed from a eutectic mixture of two metals. Alternatively, walls 310 and 312 or container 302 may be formed from a polymer material with a melting point in the desired temperature range of 120° C.-150° C.

In essence, the first and second materials 314, 316 selected should be reactive with each other when mixed, thereby providing the desired hypergolic mixture. In one embodiment, first material 314 is in liquid form, and second material 316 is formed in a granulated or powdered state, thereby maximizing surface interaction between the first liquid material 314 upon contact therewith. In a particular embodiment, first material 314 is formed from glycerol or any other suitable alcohol such as polyvinyl alcohol, and second material 316 comprises potassium permanganate.

The structure of cartridge 300 may be manufactured using any of a variety of known methods, for example molding, die casting, adhesive application, etc. Also, components 314 and 316 of the hypergolic mixture may be positioned in container 302 using any of a variety of methods. Referring to FIG. 2, in one example, a liquid component 316 of the hypergolic mixture is inserted through a hole 400 formed in central chamber 308. Hole 400 is then sealed using a suitable epoxy or other adhesive. Powdered component 316 of the hypergolic mixture is positioned within open ends of chambers 304 and 306. The chambers are then sealed or capped using known methods.

Autoignition device 300 is designed to activate when the exterior of the gas generating system housing 11 is exposed to high temperatures, thereby igniting booster charge 14 and propellant charge 38.

Device 300 is activated by breaching the walls or partitions 310, 312 separating first material 314 from second material 316, enabling the materials to mix and form a hypergolic mixture which ignites the booster charge and propellant charge. Any of several methods may be used to breach walls 310 and/or 312 separating first material 314 from second material 316.

In general, container 302 is positioned in intimate contact with the booster compound 14 and propellant 38. However, the container may be positioned such that a breach of the container structure permits first material 314 and second material 316 to flow from the breached container so as to combine into a hypergolic mixture in thermal communication with booster compound 14 and propellant 38, thereby igniting the combustible materials.

In the embodiment shown in FIG. 1, autoignition devices 300 at each end of housing 11 are positioned in intimate thermal contact with respective metallic end closures 13 and 34. Container 302 may alternatively be placed in intimate thermal contact with another component of the gas generating system formed from a suitable heat-conductive material and positioned so as to enable thermal communication between the exterior of housing 11 and container 302. Any heat to which the housing is exposed is then conducted through the end closures or other heat-conductive component (or through the housing material to the end closures) to container 302, resulting in fusion of the container material and breaching of the container including one or more of walls 310 and 312, thereby enabling mixing of materials 314 and 316.

Container 302 may be structured such that one or more of walls 310, 312 is breached to enable formation of the hypergolic mixture. The combustion reaction from formation of the mixture then results in breach of another portion of the container (via flame and/or increased internal pressure within the container) to ignite the booster charge or propellant outside the container. Alternatively, the structure of the container and the mode of inducing a breach in the separation between the first and second materials may be specified such that one or more of walls 310, 312 and an exterior wall of the container fail substantially simultaneously, resulting in combination of components 314 and 316, and exposure of the gas generants in the housing to the hypergolic mixture.

In another embodiment (not shown), an inductive heating coil is coupled to container 302 to supply heat for fusing the container material upon activation. The coil may be powered by the electrical energy source supplying an activation signal to initiator assemblies 9 and/or 12, or the coil may be powered by an alternative energy source. The coil may be activated based on any of a variety of inputs, for example, receipt by the coil energy source of a signal from a temperature sensor indicating an elevated temperature condition on the exterior of housing 11.

In yet another embodiment (not shown), container 302 (or walls 310 and 312 of container 302) are formed from a polymer material, and a metallic heating element is insert molded into (or otherwise positioned in intimate contact with) each of walls 310, and 312. When a current is applied to the heating element, resistive heat sufficient to melt walls 310 and 312 is generated, allowing first material 314 and second material 316 to form the hypergolic mixture used to ignite the propellants in the housing.

In yet another embodiment (not shown), container 302 is structured such that walls 310, 312 are formed from a layer of electrically conductive material that is relatively thin compared to the remaining structure of the material. This relatively thin material layer forms a relatively high resistance path through the container for a current applied to the container. When current is applied to the container, heat generated along the relatively high-resistance path melts the walls, thereby breaching the separation between the first and second materials to enable mixing of the materials and formation of the hypergolic compound.

In operation, gas generating system 10 is connected to an electrical activation system that includes a crash sensor, of which there are many well-known suitable types. In addition, various sensing systems may be incorporated into the vehicle electronics, including seat weight sensors, occupant detection systems, etc. During a typical deployment scenario, such as an impact or a sudden vehicle deceleration, an activation signal is sent from an onboard vehicle computer to gas generating system 10. The signal may be sent to either or both of the initiator assemblies housed with gas generating system 10. Because chamber 25 preferably contains the larger, main charge, the activation signal is typically directed initially to the initiator assembly operably associated with first chamber 25. In certain scenarios, for example with larger occupants, or where occupants are out of a normal seated position in the vehicle, it may be desirable to activate both propellant charges simultaneously. Other scenarios may call for different activation schemes. For instance, certain conditions may make it desirable to fire only the first propellant charge, or sequentially fire both charges, with varying time delays between the two events. Once an electrical activation signal is sent to the initiator associated with first chamber 25, combustion of booster propellant 14 in sub-chamber 25a is initiated. The flame front and/or hot combustion gases from booster 14 subsequently traverse disk 18, initiating combustion of propellant tablets 28a in chamber 25b. The burning of tablets 28a produces inflation gas that flows rapidly out inflation apertures 40, initiating filling of an associated airbag. A cylindrical, metallic mesh filter 116 is preferably positioned in gas generating system housing 11, and filters slag produced by the combustion of the compounds therein, also serving as a heat sink to reduce the temperature of the inflation gas. Combustion of tablets 28a initiates combustion of wafers 28b, preferably made from the same or similar material as tablets 28a, providing a sustained burn that delivers a relatively constant supply of gas to the associated airbag via plenum 21 and apertures 40. When desired, an electrical activation signal is sent to the initiator operably associated with second chamber 35, containing a gas generant composition 38 that is preferably similar to the composition in chamber 25. Rapid creation of gas in chamber 35 causes a rapid rise in the gas pressure therein, outwardly bursting the foil or shim (not shown) that covers apertures 30, in cap 29. The gas is subsequently discharged from gas generating system 10 via plenum 21 and apertures 40. Activation of the gas generant in chamber 35 can take place before, during, or after an activation signal is sent to initiator assembly 12, operably associated with chamber 25.

Because both chambers 25 and 35 discharge inflation gas through a common plenum 21, the present invention provides different operating advantages over many earlier designs wherein separate plenums are used for each combustion chamber. By discharging inflation gases from both combustion chambers 25 and 35 through plenum 21, the inflation profile characteristics across the length and width of an associated airbag can be improved as compared to earlier multi-chamber designs wherein the combustion chambers discharge via separate plenums. In addition, the use of a partitioning assembly structurally independent from the gas generating system housing sidewalls allows the gas generating system to be constructed without crimping or otherwise modifying the gas generating system housing itself. Moreover, because gas generating system 10 utilizes a plenum that is coextensive with a first of the combustion chambers, gas generating system 10 has a simpler design than multi-chamber gas generating system s utilizing combustion chambers that are both partitioned from a common plenum. Gas generating system housing 11 utilizes no attached internal partitions, and can therefore be manufactured without the need for strengthening to compensate for weakening caused by partition attachment. These and other advantages reduce the cost, manufacturing complexity, size and weight of the gas generating system.

Operation of autoignition device 300 will now be discussed for an embodiment of container 302 formed from a eutectic alloy comprising approximately 58% bismuth and approximately 42% tin by weight, with a melting point of about 138° C. as previously discussed. Referring again to FIG. 1, when the exterior of housing 11 is exposed to fire, heat from gas generating system housing 11 is transmitted to container 302. The eutectic alloy forming container 302 melts at about 138° C., thereby breaching one or more of walls 310 and 312 separating first material 314 from second material 316 and enabling the materials to combine to form a hypergolic mixture. As a result, hypergolic ignition occurs, thereby providing the necessary ignition of the remaining pyrotechnic materials in the gas generating system 10.

Referring now to FIG. 3, the exemplary gas generating system 10 described above may also be incorporated into an airbag system 200. Airbag system 200 includes at least one airbag 202 and a gas generating system 10 in accordance with the present invention, coupled to airbag 202 so as to enable fluid communication with an interior of the airbag. Airbag system 200 may also include (or be in communication with) a crash event sensor 210. Crash event sensor 210 operates in conjunction with a known crash sensor algorithm that signals actuation of airbag system 200 via, for example, activation of airbag gas generating system 10 in the event of a collision.

Referring again to FIG. 3, airbag system 200 may also be incorporated into a broader, more comprehensive vehicle occupant restraint system 180 including additional elements such as a safety belt assembly 150. FIG. 3 shows a schematic diagram of one exemplary embodiment of such a restraint system. Safety belt assembly 150 includes a safety belt housing 152 and a safety belt 100 extending from housing 152. A safety belt retractor mechanism 154 (for example, a spring-loaded mechanism) may be coupled to an end portion of the belt. In addition, a safety belt pretensioner 156 may be coupled to belt retractor mechanism 154 to actuate the retractor mechanism in the event of a collision. Typical seat belt retractor mechanisms which may be used in conjunction with the safety belt embodiments of the present invention are described in U.S. Pat. Nos. 5,743,480, 5,553,803, 5,667,161, 5,451,008, 4,558,832 and 4,597,546, incorporated herein by reference. Illustrative examples of typical pretensioners with which the safety belt embodiments of the present invention may be combined are described in U.S. Pat. Nos. 6,505,790 and 6,419,177, incorporated herein by reference.

Safety belt assembly 150 may also include (or be in communication with) a crash event sensor 158 (for example, an inertia sensor or an accelerometer) operates in conjunction with a known crash sensor algorithm that signals actuation of belt pretensioner 156 via, for example, activation of a pyrotechnic igniter (not shown) incorporated into the pretensioner. U.S. Pat. Nos. 6,505,790 and 6,419,177, previously incorporated herein by reference, provide illustrative examples of pretensioners actuated in such a manner.

It should be appreciated that safety belt assembly 150, airbag system 200, and more broadly, vehicle occupant protection system 180 exemplify but do not limit gas generating systems contemplated in accordance with the present invention.

It will be understood that the foregoing description of the present invention is for illustrative purposes only, and that the various structural and operational features herein disclosed are susceptible to a number of modifications, none of which departs from the spirit and scope of the present invention. The preceding description, therefore, is not meant to limit the scope of the invention. Rather, the scope of the invention is to be determined only by the appended claims and their equivalents.

What is claimed is:

1. A cartridge comprising:
a container;
a first material stored in the container; and
a second material stored in the container, the second material being separated from the first material, the first material and the second material forming a hypergolic mixture upon contact with each other.

2. The cartridge of claim 1 wherein a wall separates the first material from the second material so as to enable the first material to contact the second material upon breaching of the wall.

3. The cartridge of claim 2 wherein the material of the wall is fusible.

4. The cartridge of claim 3 wherein the wall is formed from a metallic material having a melting point in the range 120° C.-150° C.

5. The cartridge of claim 4 wherein the melting point of the metallic material is about 138° C.

6. The cartridge of claim 4 wherein the metallic material comprises approximately 58% Bismuth and approximately 42% tin.

7. The cartridge of claim 4 wherein the metallic material is formed from an alloy comprising at least two of the following materials: Bismuth, Lead, Tin, Cadmium, Antimony, Indium.

8. The cartridge of claim 4 wherein the metallic material is formed from a eutectic mixture of two metals.

9. The cartridge of claim 2 wherein the wall is formed from a polymer material.

10. The cartridge of claim 1 wherein at least a portion of the material of the container is fusible.

11. The cartridge of claim 1 wherein the first material comprises an alcohol and the second material comprises potassium permanganate.

12. The cartridge of claim 11 wherein the alcohol is glycerol.

13. The cartridge of claim 11 wherein the alcohol is polyvinyl alcohol.

14. The cartridge of claim 1 wherein the container includes:
a first chamber containing a quantity of the second material;
a second chamber separated from the first chamber, the second chamber containing a quantity of the second material; and
a third chamber positioned adjacent the first and second chambers, the third chamber separated from both the first and second chambers, the third chamber containing a quantity of the first material.

15. A method of forming a hypergolic mixture, the method comprising the steps of:
positioning a first component of the hypergolic mixture in a container;
positioning a second component of the hypergolic mixture in the container separated from the first component; and
breaching at least a portion of the container so as to provide contact between the first component and the second component, thereby forming the hypergolic mixture.

16. A method of igniting a combustible material, the method comprising the steps of:
positioning a first component of a hypergolic mixture in a container;
positioning a second component of the hypergolic mixture in the container separated from the first component; and
breaching at least a portion of the container so as to provide contact between the first component and the second component proximate the combustible material, thereby forming a hypergolic mixture proximate the combustible material to ignite the combustible material.

17. A gas generating system comprising:
a housing;
a gas generant positioned in the housing;
an ignition device for igniting the gas generant, the ignition device including a container, a first material stored in the container, and a second material stored in the container, the second material being separated from the first material such that a breach in the separation enables the first material to contact the second material, wherein the first material and the second material form a hypergolic mixture upon contact with each other to ignite the gas generant.

18. A vehicle occupant protection system comprising:
an inflatable vehicle occupant restraint device; and
a gas generating system coupled to the inflatable restraint device for providing inflation fluid to inflate the vehicle occupant restraint device, the gas generating system including a cartridge according to claim 1.
